(19) United States
(12) Patent Application Publication
(10) Pub. No.: US 2015/0379653 A1
(43) Pub. Date: Dec. 31, 2015

(54) SYSTEM AND METHOD FOR LICENSE DETECTION AND GENERATING LICENSE REMINDERS

(71) Applicant: Nuance Communications, Inc., Burlington, MA (US)

(72) Inventors: Andreas Neubacher, Wien (AT); Siegmar Marseiler, Vienna (AT); Georg Kabesch, Wien (AT)

(21) Appl. No.: 14/315,833

(22) Filed: Jun. 26, 2014

(51) Int. Cl. G06Q 50/18

(52) U.S. Cl. CPC G06Q 50/184; G06Q 2220/18

(57) ABSTRACT

A system and method for license detection is provided. Embodiments may include receiving, at a device, a recording of a speech signal associated with an audio recording application and determining if the audio recording application has an active license. Embodiments may also include inserting license reminder language to the speech signal if it is determined that the audio recording application does not have an active license and ignoring the license reminder language if it is determined that the audio recording application does have an active license. Embodiments may further include producing an output signal wherein the output signal includes the license reminder language if it is determined that the audio recording application does not have an active license and producing an output signal without the license reminder language if it is determined that the audio recording application does have an active license.

### TECHNICAL FIELD

This disclosure relates generally to a method for software licensing.

### BACKGROUND

Perpetual licenses that install once with the software and are then usable for an unlimited amount of time are generally undesirable for various reasons. In some environments, such as healthcare, if licenses are only issued for a limited amount of time, it is not acceptable if the termination of the license creates a denial of service situation for the end users. Alternatively, after termination of a license the functionality cannot be kept active for an unlimited extension period, as this would counteract the purpose of license enforcement.

Some existing approaches to this problem include shareware, nagware, visible watermarking, and invisible audio watermarking. Shareware/Nagware is a well known business model where software may be distributed for free, but regularly generates pop-up dialogs or denies certain features until a full license has been bought and installed. Visible watermarking is also a well-known practice. Here, unlicensed deployments of image processing software may overlay some text (e.g., indicating that it was created with an unlicensed version of the software) over images, or text processing software may insert similar text in the header or footer of each page. Invisible audio watermarking may involve the generation of an inaudible digital signal (e.g. some unique identifier) that is mixed into the audio data in such a way that it can be extracted again even if the audio is manipulated (e.g. compressed) and can thus be used to prove the provenance of the audio data.

### SUMMARY OF DISCLOSURE

In one implementation, a method for license detection is provided. The method may include receiving, at a device, a recording of a speech signal associated with an audio recording application and determining if the audio recording application has an active license. The method may also include inserting license reminder language to the speech signal if it is determined that the audio recording application does not have an active license and ignoring the license reminder language if it is determined that the audio recording application does have an active license. The method may further include producing an output signal wherein the output signal includes the license reminder language if it is determined that the audio recording application does not have an active license and producing an output signal without the license reminder language if it is determined that the audio recording application does have an active license.

One or more of the following features may be included. In some embodiments, producing may include audio playback of the output signal. Producing may also include text-based generation of the output signal. In some embodiments, the license reminder language may be at least one of a pre-recorded audio message and an audio message that is generated from text using a text-to-speech process. The license reminder language may be inserted at at least one of the beginning and the end of the output signal. The license reminder language may be inserted at one or more intervals associated with the output signal. The method may further include processing, via a speech recognition engine, the speech signal with the license reminder language and training the license reminder language using one or more of an acoustic model and a language model.

In another implementation, a system for license detection is provided. The system may include one or more processors configured to receive a recording of a speech signal using an audio recording application. The one or more processors may be further configured to determine if the audio recording application has an active license, the one or more processors further configured to insert license reminder language to the speech signal if it is determined that the audio recording application does not have an active license and ignore the license reminder language if it is determined that the audio recording application does have an active license. The one or more processors may be further configured to produce an output signal wherein the output signal includes the license reminder language if it is determined that the audio recording application does not have an active license and produce an output signal without the license reminder language if it is determined that the audio recording application does have an active license.

One or more of the following features may be included. In some embodiments, producing may include audio playback of the output signal. Producing may also include text-based generation of the output signal. In some embodiments, the license reminder language may be at least one of a pre-recorded audio message and an audio message that is generated from text using a text-to-speech process. The license reminder language may be inserted at at least one of the beginning and the end of the output signal. The license reminder language may be inserted at one or more intervals associated with the output signal.

In another implementation, a non-transitory computer-readable storage medium is provided. The non-transitory computer-readable storage medium may have stored thereon instructions, which when executed by a processor result in one or more operations. The operations may include recording, at a device, a speech signal using an audio recording application and determining if the audio recording application has an active license. Operations may also include inserting license reminder language to the speech signal if it is determined that the audio recording application does not have an active license and ignoring the license reminder language if it is determined that the audio recording application does have an active license. Operations may further include producing an output signal wherein the output signal includes the license reminder language if it is determined that the audio recording application does not have an active license and producing an output signal without the license reminder language if it is determined that the audio recording application does have an active license.

One or more of the following features may be included. In some embodiments, producing may include audio playback of the output signal. Producing may also include text-based generation of the output signal. In some embodiments, the license reminder language may be a pre-recorded audio message. The license reminder language may be inserted at the beginning of the output signal. The license reminder language may be inserted at one or more intervals associated with of the output signal. Operations may further include processing, via a speech recognition engine, the speech signal with the license reminder language and training the license reminder language using one or more of an acoustic model and a language model.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an example of a license detection process in accordance with an embodiment of the present disclosure;

FIG. 2 is a diagrammatic view of an example of a license detection process in accordance with an embodiment of the present disclosure;

FIG. 3 is a diagrammatic view of an example of a license detection process;

FIG. 4 is a diagrammatic view of an example of a license detection process in accordance with an embodiment of the present disclosure;

FIG. 5 is a flowchart of a license detection process in accordance with an embodiment of the present disclosure; and

FIG. 6 shows an example of a computer device and a mobile computer device that can be used to implement the license detection process described herein;

Like reference symbols in the various drawings may indicate like elements.

### DETAILED DESCRIPTION

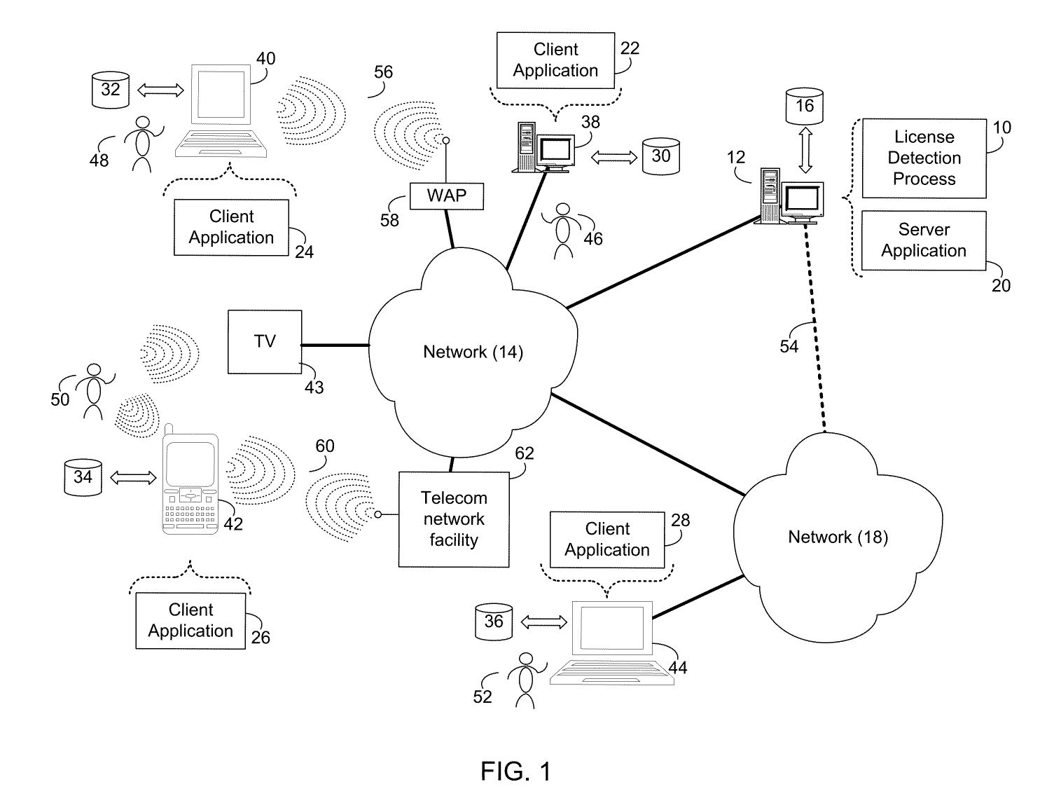

Embodiments provided herein are directed towards a system and method for software licensing. In some embodiments, license detection process 10, shown in FIG. 1 and described herein, may be configured to determine whether a software application has an active license in place and, if not, may insert language (e.g. an audio message, textual insert, etc.) indicating that an audio recording (e.g. a dictated recording) was recorded with an unlicensed version of the software. Accordingly, embodiments of the present disclosure allow for graceful degradation in the system that alerts administrators and end users to the fact that they need to refresh the license while still providing them with the required product functionality. While such a message is sufficiently intrusive in workflow steps such as speech recognition draft correction or playback/listen-in scenarios, it does not affect the end user during use (e.g., a doctor from doing his/her job at the critical point of care).

Referring to FIG. 1, there is shown a license detection process 10 that may reside on and may be executed by computer 12, which may be connected to network 14 (e.g., the Internet or a local area network). Server application 20 may include some or all of the elements of license detection process 10 described herein. Examples of computer 12 may include but are not limited to a single server computer, a series of server computers, a single personal computer, a series of personal computers, a mini computer, a mainframe computer, an electronic mail server, a social network server, a text message server, a photo server, a multiprocessor computer, one or more virtual machines running on a computing cloud, and/or a distributed system. The various components of computer 12 may execute one or more operating systems, examples of which may include but are not limited to: Microsoft Windows Server™; Novell Netware™; Redhat Linux™, Unix, or a custom operating system, for example.

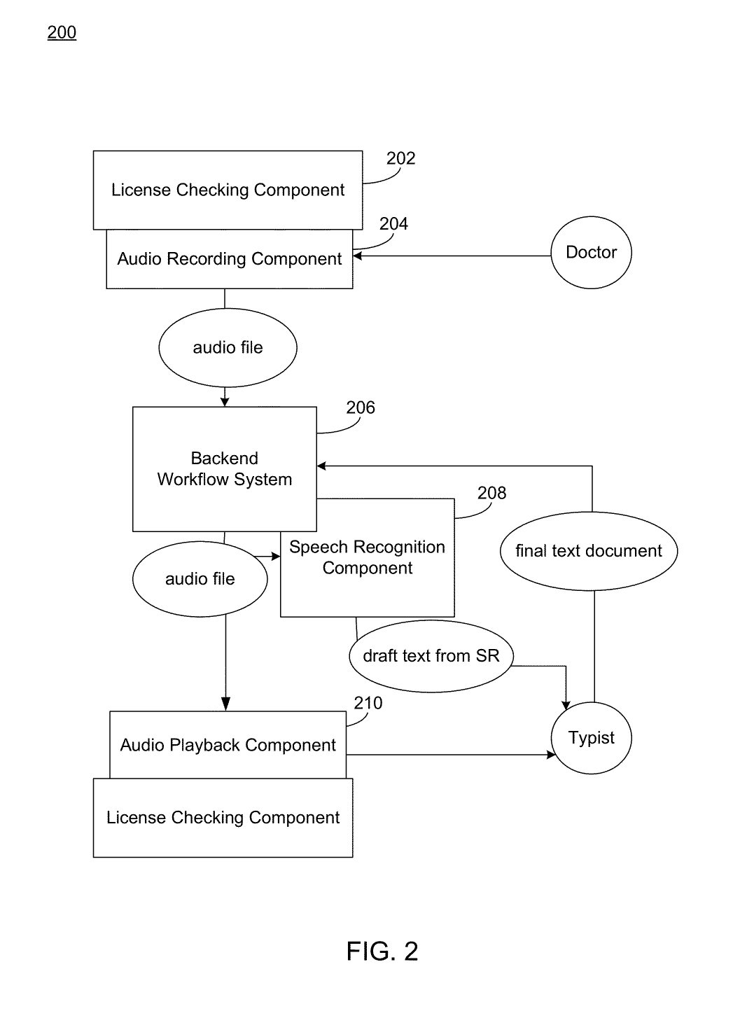

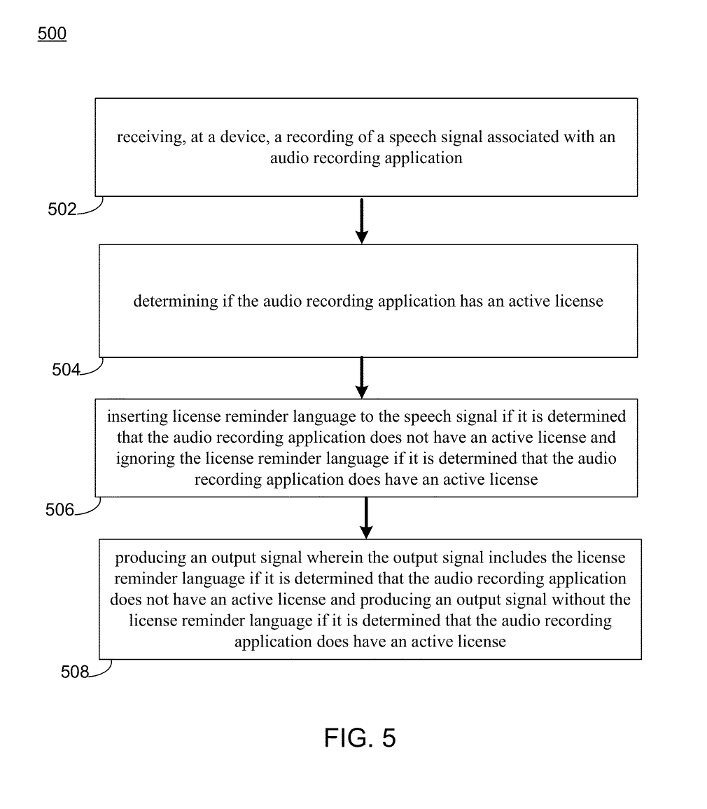

As will be discussed below in greater detail in FIGS. 2-6, license detection process 10 may include receiving (502), at a device, a recording of a speech signal associated with an audio recording application and determining (504) if the audio recording application has an active license. Embodiments may also include inserting (506) license reminder language to the recorded speech signal if it is determined that the audio recording application does not have an active license and ignoring the license reminder language if it is determined that the audio recording application does have an active license. Embodiments may further include producing (508) an output signal wherein the output signal includes the license reminder language if it is determined that the audio recording application does not have an active license and producing an output signal without the license reminder language if it is determined that the audio recording application does have an active license.

The instruction sets and subroutines of license detection process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

In some embodiments, license detection process 10 may be accessed and/or activated via client applications 22, 24, 26, 28. Examples of client applications 22, 24, 26, 28 may include but are not limited to a standard web browser, a customized web browser, or a custom application that can display data to a user. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively).

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, television 43, notebook computer 44, a server (not shown), a data-enabled, cellular telephone (not shown), a dedicated network device (not shown), an audio recording device, etc.

One or more of client applications 22, 24, 26, 28 may be configured to effectuate some or all of the functionality of license detection process 10. Accordingly, license detection process 10 may be a purely server-side application, a purely client-side application, or a hybrid server-side/client-side application that is cooperatively executed by one or more of client applications 22, 24, 26, 28 and license detection process 10.

Client electronic devices 38, 40, 42, 44 may each execute an operating system, examples of which may include but are not limited to Apple iOS™, Microsoft Windows™, Android™, Redhat Linux™, or a custom operating system. In some cases, the client electronic device may include audio recording functionality and/or may be an audio recording device. Additionally and/or alternatively, in some embodiments an audio recording device may be in communication with one or more of the client electronic devices as is discussed in further detail herein.

Users 46, 48, 50, 52 may access computer 12 and license detection process 10 directly through network 14 or through secondary network 18. Further, computer 12 may be connected to network 14 through secondary network 18, as illustrated with phantom link line 54. In some embodiments, users may access license detection process 10 through one or more telecommunications network facilities 62.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and smart phones to be interconnected using a short-range wireless connection.

Smart phone 42 is shown wirelessly coupled to network 14 via wireless communication channel 60 established between smart phone 42 and telecommunications network facility 62, which is shown directly coupled to network 14. In some embodiments, smartphone 42 may be an audio recording device or may include audio recording functionality and may enable an end user to record a speech signal. The speech signal may be stored and/or transmitted to any of the devices described herein. For example, transmitted over network 14 to client electronic device 40.

The phrase “telecommunications network facility”, as used herein, may refer to a facility configured to transmit, and/or receive transmissions to/from one or more mobile devices (e.g. cellphones, etc). In the example shown in FIG. 1, telecommunications network facility 62 may allow for communication between any of the computing devices shown in FIG. 1 (e.g., between cellphone 42 and server computing device 12).

Referring now to FIG. 2, a diagram consistent with an embodiment of license detection process 10 is provided. In some embodiments, a license checking component 202 may be included. License checking component 202 may be configured to determine (504) if the audio recording application has an active license. Audio recording component 204 may enable the recording (502) of a speech signal using an audio recording application and/or audio recording device (e.g. a handheld audio recorder). For example, user 50 of FIG. 1 may need to create a dictation, which may be stored persistently in an audio file as shown in FIG. 2.

In some embodiments, audio recording component 204 may be configured to insert (506) license reminder language to the speech signal if it is determined that the audio recording application does not have an active license. Accordingly, license detection process 10 may be configured to produce an output signal wherein the output signal includes the license reminder language if it is determined that the audio recording application does not have an active license and producing an output signal without the license reminder language if it is determined that the audio recording application does have an active license. In this way, audio recording component 204 may ignore the license reminder language if it is determined that the audio recording application does have an active license. License detection process 10 may inject a license reminder language into the audio file if it is determined that the software is not licensed or has an expired license.

In some embodiments, the output signal may be produced using any suitable technique. Some of these may include, but are not limited to, audio playback of the output signal, text-based generation of the output signal, etc.

In some embodiments, the license reminder language may be a pre-recorded audio message. In other embodiments, the license reminder language may be an audio message that is created by applying a text-to-speech process from a dynamically generated text string that may contain for example the user name or the name of the organization that is using the software to which the license applies. The license reminder language may be inserted at any suitable position within the output signal. For example, at the beginning of the output signal, at one or more intervals associated with of the output signal, at the end of the output signal, etc.

In some embodiments, backend workflow system 206 may be configured to integrate a speech recognition component and, in some embodiments, may also implement a pure digital dictation workflow. Speech Recognition Component 208 may be configured to inject a textual representation of the license reminder language into draft text. In the event that the software is licensed speech recognition component 208 may be configured to filter or skip the insertion of the license enforcement audio messages if the system is licensed. Audio playback component 210 may allow an end user, such as a data entry employee, to create a text document from the dictated audio. In some embodiments, audio playback component 210 may be configured to inject an additional license enforcement audio message during playback if playback is not licensed. Additionally and/or alternatively, audio playback component 210 may be configured to filter or skip any license enforcement audio messages that may be present in the audio file if the system is licensed.

In some embodiments, in operation, audio recording component 204 may detect the lack of a license and may insert a pre-recorded license reminder audio message (e.g., “This dictation has been recorded with an unlicensed version of <product name>”) at various positions (e.g., the beginning, the end, and/or at x-second intervals) into the audio stream. Speech Recognition Component 208 may detect this injected audio block and ignore it if the system is re-licensed. Otherwise, it may produce corresponding text with special markup (e.g., “[[THIS DICTATION HAS BEEN RECORDED WITH AN UNLICENSED VERSION OF <product name>]]”) into the draft. These sections may be ignored during profile optimization.

In some embodiments, detection may be realized in using any suitable technique. For example, the pre-recorded license reminder audio message may be trained specially in the “factory default” acoustic and language models. In some cases, the pre-recorded license reminder audio message may contain a mixed in marker signal that can be detected during signal processing. In some embodiments, a speech recognition engine may be configured to process the speech signal with embedded license reminder language. For example, in some instances the system may detect and skip this license reminder language if the component is licensed.

In some embodiments, when the playback component is licensed, it may detect and skip the injected audio blocks. Otherwise, it may play back all audio, thus making the listener aware of the unlicensed state of the system. Furthermore, if the playback component is unlicensed and it should play back audio that does not contain a “license reminder” it may inject the license reminder into the played back audio stream.

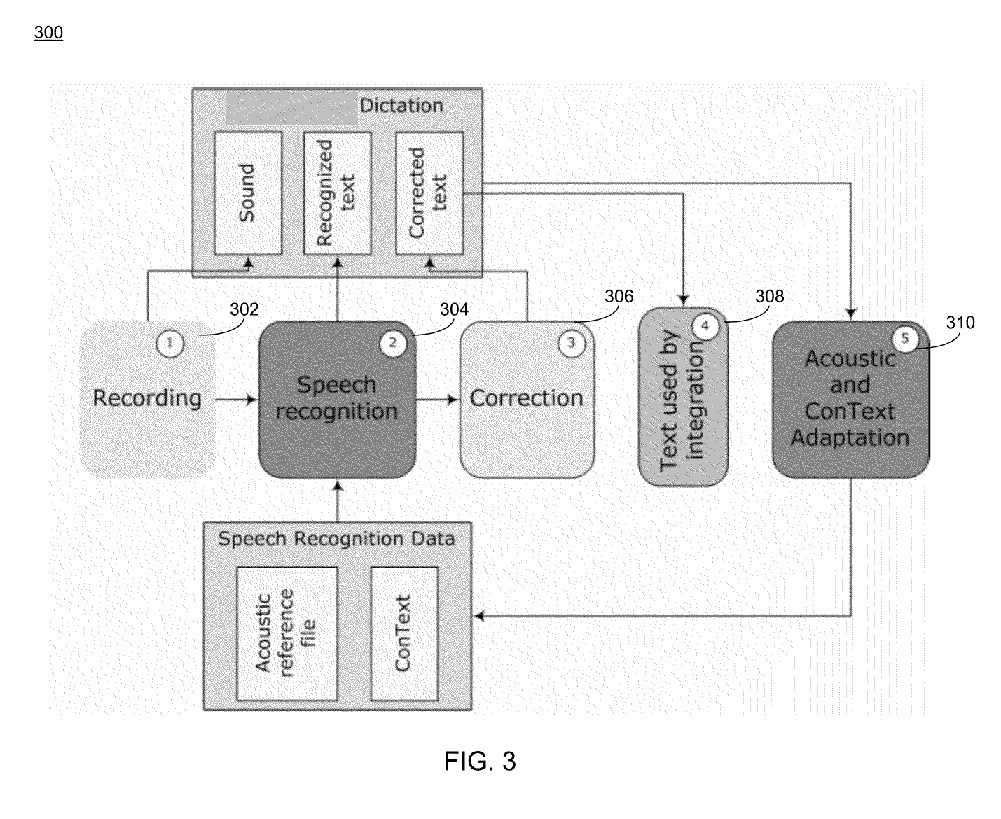

Referring now to FIG. 3, an embodiment of a backend recognition system that may be used in accordance with license detection process 10 is provided. In operation, speech may be digitally recorded 302 and the recorded speech may be sent to the speech recognition engine 304 and converted into recognition results (text and commands), using speech recognition data. The recognized text may be corrected 306 and the corrected text may be available to the integration 308 for further processing. The corrected dictation may be used as feedback in the Acoustic Adaptation and ConText Adaptation module 310 to update the acoustic reference file and the ConText.

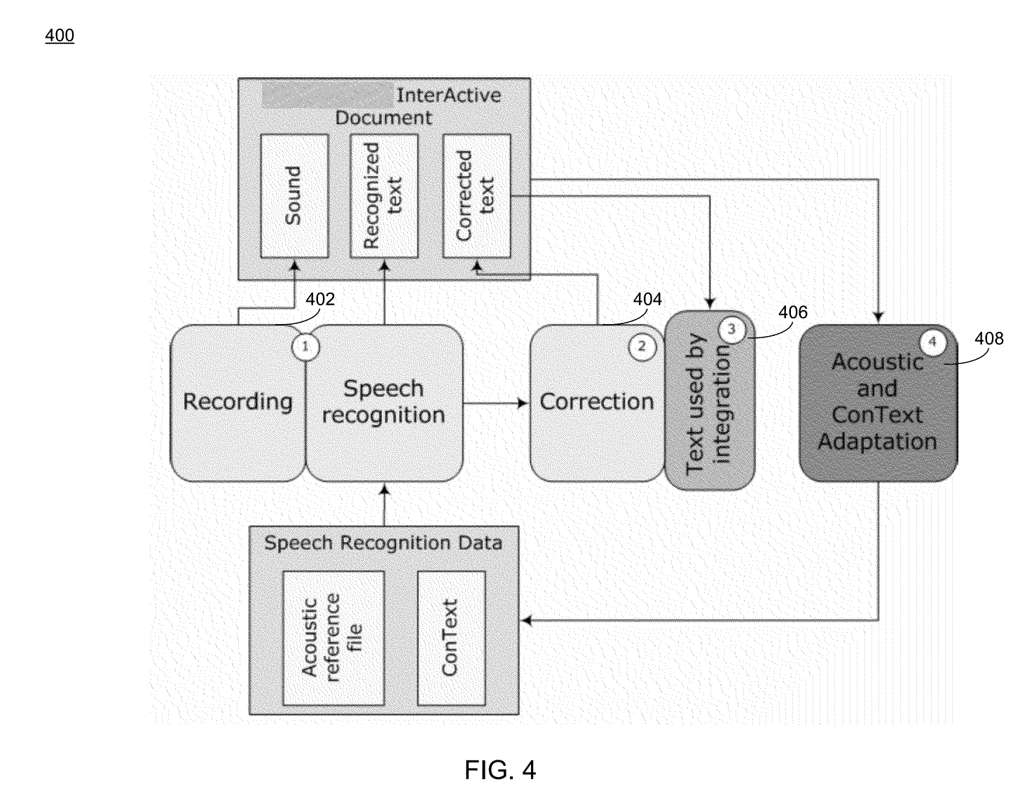

Referring now to FIG. 4, an embodiment of a frontend recognition system that may be used in accordance with license detection process 10 is provided. In operation, speech may be digitally recorded 402 and immediately fed into the speech recognition engine where it may be converted into recognition results (text and commands), using speech recognition data. The recognized text may be corrected 404, for example, by a correctionist, by the author, automatically, etc. Because the recognized text is usually corrected directly in the integration 406 it may be immediately available for further processing. The final InterActive document may be uploaded to the Backend and may be used as feedback in Acoustic Adaptation and ConText Adaptation module 408 to update the acoustic reference file and the ConText.

Embodiments of license detection process 10 may be used in any suitable environment such as those depicted in FIGS. 3-4. In some embodiments, license detection process 10 may work in conjunction with healthcare applications such as the SpeechMagic system available from the Assignee of the present disclosure.

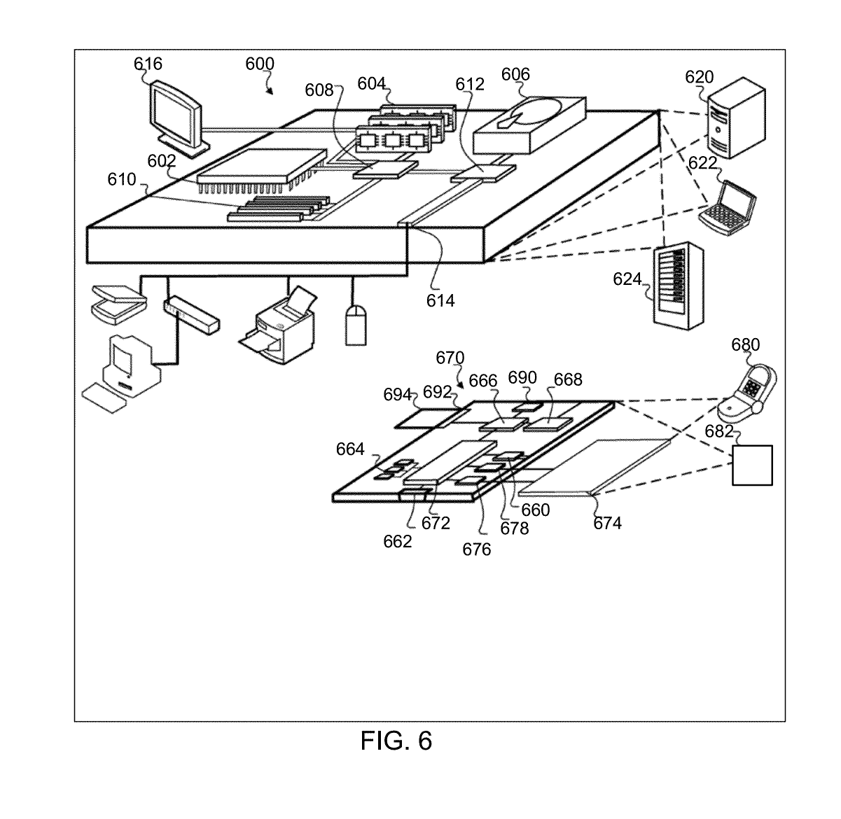

Referring now to FIG. 6, an example of a generic computer device 600 and a generic mobile computer device 670, which may be used with the techniques described here is provided. Computing device 600 is intended to represent various forms of digital computers, such as tablet computers, laptops, desktops, workstations, personal digital assistants, servers, blade servers, mainframes, and other appropriate computers. In some embodiments, computing device 670 can include various forms of mobile devices, such as personal digital assistants, cellular telephones, smartphones, and other similar computing devices. Computing device 670 and/or computing device 600 may also include other devices, such as televisions with one or more processors embedded therein or attached thereto. The components shown here, their connections and relationships, and their functions, are meant to be exemplary only, and are not meant to limit implementations of the inventions described and/or claimed in this document.

In some embodiments, computing device 600 may include processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, may be interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

Memory 604 may store information within the computing device 600. In one implementation, the memory 604 may be a volatile memory unit or units. In another implementation, the memory 604 may be a non-volatile memory unit or units. The memory 604 may also be another form of computer-readable medium, such as a magnetic or optical disk.

Storage device 606 may be capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

High speed controller 608 may manage bandwidth-intensive operations for the computing device 600, while the low speed controller 612 may manage lower bandwidth-intensive operations. Such allocation of functions is exemplary only. In one implementation, the high-speed controller 608 may be coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 670. Each of such devices may contain one or more of computing device 600, 670, and an entire system may be made up of multiple computing devices 600, 670 communicating with each other.

Computing device 670 may include a processor 672, memory 664, an input/output device such as a display 674, a communication interface 666, and a transceiver 668, among other components. The device 670 may also be provided with a storage device, such as a microdrive or other device, to provide additional storage. Each of the components 670, 672, 664, 674, 666, and 668, may be interconnected using various buses, and several of the components may be mounted on a common motherboard or in other manners as appropriate.

Processor 672 may execute instructions within the computing device 670, including instructions stored in the memory 664. The processor may be implemented as a chipset of chips that include separate and multiple analog and digital processors. The processor may provide, for example, for coordination of the other components of the device 670, such as control of user interfaces, applications run by device 670, and wireless communication by device 670.

In some embodiments, processor 672 may communicate with a user through control interface 678 and display interface 676 coupled to a display 674. The display 674 may be, for example, a TFT LCD (Thin-Film-Transistor Liquid Crystal Display) or an OLED (Organic Light Emitting Diode) display, or other appropriate display technology. The display interface 676 may comprise appropriate circuitry for driving the display 674 to present graphical and other information to a user. The control interface 678 may receive commands from a user and convert them for submission to the processor 672. In addition, an external interface 662 may be provide in communication with processor 672, so as to enable near area communication of device 670 with other devices. External interface 662 may provide, for example, for wired communication in some implementations, or for wireless communication in other implementations, and multiple interfaces may also be used.

In some embodiments, memory 664 may store information within the computing device 670. The memory 664 can be implemented as one or more of a computer-readable medium or media, a volatile memory unit or units, or a non-volatile memory unit or units. Expansion memory 674 may also be provided and connected to device 670 through expansion interface 672, which may include, for example, a SIMM (Single In Line Memory Module) card interface. Such expansion memory 674 may provide extra storage space for device 670, or may also store applications or other information for device 670. Specifically, expansion memory 674 may include instructions to carry out or supplement the processes described above, and may include secure information also. Thus, for example, expansion memory 674 may be provide as a security module for device 670, and may be programmed with instructions that permit secure use of device 670. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 664, expansion memory 674, memory on processor 672, or a propagated signal that may be received, for example, over transceiver 668 or external interface 662.

Device 670 may communicate wirelessly through communication interface 666, which may include digital signal processing circuitry where necessary. Communication interface 666 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 670, which may be used as appropriate by applications running on device 670.

Device 670 may also communicate audibly using audio codec 660, which may receive spoken information from a user and convert it to usable digital information. Audio codec 660 may likewise generate audible sound for a user, such as through a speaker, e.g., in a handset of device 670. Such sound may include sound from voice telephone calls, may include recorded sound (e.g., voice messages, music files, etc.) and may also include sound generated by applications operating on device 670.

Computing device 670 may be implemented in a number of different forms, as shown in the figure. For example, it may be implemented as a cellular telephone 680. It may also be implemented as part of a smartphone 682, personal digital assistant, remote control, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method for license detection comprising:
receiving, at a device, a recording of a speech signal associated with an audio recording application;
determining if the audio recording application has an active license;
inserting license reminder language to the speech signal if it is determined that the audio recording application does not have an active license and ignoring the license reminder language if it is determined that the audio recording application does have an active license; and
producing an output signal wherein the output signal includes the license reminder language if it is determined that the audio recording application does not have an active license and producing an output signal without the license reminder language if it is determined that the audio recording application does have an active license.

2. The method of claim 1, wherein producing includes audio playback of the output signal.

3. The method of claim 1, wherein producing includes text-based generation of the output signal.

4. The method of claim 1, wherein the license reminder language is at least one of a pre-recorded audio message and an audio message that is generated from text using a text-to-speech process.

5. The method of claim 1, wherein the license reminder language is inserted at at least one of the beginning and the end of the output signal.

6. The method of claim 1, wherein the license reminder language is inserted at one or more intervals associated with the output signal.

7. The method of claim 1, further comprising:
processing, via a speech recognition engine, the speech signal with the license reminder language; and
training the license reminder language using one or more of an acoustic model and a language model.

8. A non-transitory computer-readable storage medium having stored thereon instructions, which when executed by a processor result in one or more operations, the operations comprising:
receiving, at a device, a recording of a speech signal associated with an audio recording application;
determining if the audio recording application has an active license;
inserting license reminder language to the speech signal if it is determined that the audio recording application does not have an active license and ignoring the license reminder language if it is determined that the audio recording application does have an active license; and
producing an output signal wherein the output signal includes the license reminder language if it is determined that the audio recording application does not have an active license and producing an output signal without the license reminder language if it is determined that the audio recording application does have an active license.

9. The non-transitory computer-readable storage medium of claim 8, wherein producing includes audio playback of the output signal.

10. The non-transitory computer-readable storage medium of claim 8, wherein producing includes text-based generation of the output signal.

11. The non-transitory computer-readable storage medium of claim 8, wherein the license reminder language is a pre-recorded audio message.

12. The non-transitory computer-readable storage medium of claim 8, wherein the license reminder language is inserted at the beginning of the output signal.

13. The non-transitory computer-readable storage medium of claim 8, wherein the license reminder language is inserted at one or more intervals associated with the output signal.

14. The non-transitory computer-readable storage medium of claim 8, further comprising:
processing, via a speech recognition engine, the speech signal with the license reminder language; and
training the license reminder language using one or more of an acoustic model and a language model.

15. A system for license detection comprising:
one or more processors configured to receive a recording of a speech signal associated with an audio recording application, the one or more processors further configured to determine if the audio recording application has an active license, the one or more processors further configured to insert license reminder language to the speech signal if it is determined that the audio recording application does not have an active license and ignore the license reminder language if it is determined that the audio recording application does have an active license, the one or more processors further configured to produce an output signal wherein the output signal includes the license reminder language if it is determined that the audio recording application does not have an active license and produce an output signal without the license reminder language if it is determined that the audio recording application does have an active license.

16. The system of claim 15, wherein producing includes audio playback of the output signal.

17. The system of claim 15, wherein producing includes text-based generation of the output signal.

18. The system of claim 15, wherein the license reminder language is a pre-recorded audio message.

19. The system of claim 15, wherein the license reminder language is inserted at the beginning of the output signal.

20. The system of claim 15, wherein the license reminder language is inserted at one or more intervals associated with the output signal.
